(19) United States
(12) Patent Application Publication
(10) Pub. No.: US 2013/0084372 A1
(43) Pub. Date: Apr. 4, 2013

(54) Whole-Muscle Jerky Slice Production Using Bulk Form Processing

(71) Applicant: Roger Kenneth Lipinski, Salisbury, MD (US)

(72) Inventor: Roger Kenneth Lipinski, Salisbury, MD (US)

(21) Appl. No.: 13/630,032

(22) Filed: Sep. 28, 2012

Related U.S. Application Data
(60) Provisional application No. 61/626,704, filed on Sep. 30, 2011.

(51) Int. Cl. A23L 1/31; A23L 1/318; A23B 4/03; A23P 1/08; A23L 1/317; A23L 1/314; A23B 4/06

(52) U.S. Cl. 426/281; 426/444; 426/295; 426/393

(57) ABSTRACT

An automated method for producing whole-muscle jerky slices using bulk form processing, and further provides jerky slices of novel composition resulting from the practice of such a method. The automated method forms a chilled bulk form of meat from multiple pieces of meat having intact muscle fiber and slices the chilled bulk form. This bulk form processing reduces raw material and labor costs relative to conventional methods for producing whole-muscle jerky slices that require large slabs of meat as input to the production process and substantial human intervention in the production process (e.g., hand-loading and placement). The jerky slices comprise integrated portions of dried meat having intact muscle fiber sourced from multiple animals and cut from a single bulk form.

### CROSS-REFERENCE TO RELATED APPLICATION

This application claims the benefit of U.S. provisional application Ser. No. 61/626,704 filed on Sep. 30, 2011 and entitled “Automated Method and System for Preparing a Jerky Food Product with Intact Muscle Fiber.”

### BACKGROUND OF THE INVENTION

The present invention relates to food preparation and, more particularly, an automated method for preparing jerky slices having intact muscle fiber and jerky slices of novel composition resulting from the practice of such a method.

Jerky products include a wide array of dried meat food products consumed by humans and pets. Some jerky products are made from cuts of meat that have intact muscle fiber and thus retain the appearance of natural meat. These whole-muscle jerky products can often be sold at a premium price relative to jerky products made from blended meat.

Large-scale production of whole-muscle jerky slices may be accomplished using different methods. In one conventional method, whole-muscle jerky slices are cut from large slabs of chilled meat. A large slab is deposited in a freezing chamber and remains there until frozen or sufficiently chilled to permit the slab to be cut into thin slices. Once the slab is suitably chilled or frozen, the slab is removed from the freezer and cut into thin slices having as uniform a thickness as possible. The slices are then injected or tumbled with additional ingredients such as curing agents or seasonings. The treated slices are then deposited on a conveyor belt, or placed on a tray, or hung on hooks and moved to a drying chamber. Either before or after the slices enter the drying chamber, they start to thaw and, once thawed, remain in the drying chamber until sufficient moisture is removed to enable the slices to be stored at room temperature for an extended period. At this point, the slices can be considered jerky slices. If additional flavoring or shelf life is desired, the jerky slices may be smoked. Smoking may be accomplished either within the drying chamber or in a separate smoke room. The jerky slices are eventually transmitted to a packaging station where they are packaged for sale.

One problem associated with producing whole-muscle jerky products using the described method is that it is labor intensive. Because the slabs of meat are non-uniform, they must be hand-loaded into the slicing machine. Additionally, once the slabs are cut into slices, the slices must still be injected or tumbled to add curing agents or seasonings. Because of this, and to ensure adequate separation for drying, each slice must be hand-placed onto a conveyor belt, tray or hook. The intense physical labor required makes whole-muscle jerky products manufactured using this method very expensive.

Another problem associated with producing whole-muscle jerky products using the described method is that it requires large slabs of meat as an input to the system. Large slabs of meat are more expensive than smaller pieces or residual trimmings generated attendant to producing other meat products and thus the requirement of large slabs increases the cost of the final product.

In another conventional method for large scale production, non-whole- muscle jerky products are produced using an extrusion process wherein the jerky products are formed by cutting or slicing an extruded meat dough. The meat dough is typically blended prior to being extruded, which breaks-down the muscle fiber and causes the meat to lose the natural appearance of meat. Thus, while lower material and labor costs are incurred in this conventional method, the method outputs a more processed product that is less desirable to consumers.

Outside of jerky product manufacturing, it is common practice to encase meat in suitable shapes for further processing. The encased meat is typically blended meat and may include sufficient binders to cause it to adhere in a solid mass in its own right. Many of these practices employ plastic casings that are not permeable to water. Though these casings may take any suitable shape, often a sausage shape is employed having a generally circular cross section. The plastic casings serve the dual benefit of forming a bulk shape as well as serving as a vessel within which the product is cooked. By cooking the meat in the casing, water is retained and yields improve, thereby reducing the product cost.

### SUMMARY OF THE INVENTION

The present invention provides an automated method for producing whole-muscle jerky slices using bulk form processing, and further provides jerky slices of novel composition resulting from the practice of such a method. The automated method of the present invention forms a chilled bulk form of meat from multiple pieces of meat having intact muscle fiber and slices the chilled bulk form. This bulk form processing reduces raw material and labor costs relative to conventional methods for producing whole-muscle jerky slices that require large slabs of meat as input to the production process and substantial human intervention in the production process (e.g., hand-loading and placement). The jerky slices of the present invention comprise integrated portions of dried meat having intact muscle fiber sourced from multiple animals and cut from a single bulk form.

In one aspect of the invention, an automated method for producing whole-muscle jerky slices comprises the steps of forming, by an automated system, a chilled bulk form from a plurality of separate meat pieces having intact muscle fiber; slicing, by the system, the chilled bulk form into a plurality of meat slices having intact muscle fiber; placing, by the system, the meat slices on a conveyor and drying, by the system, the meat slices.

In some embodiments, the forming step comprises stuffing the meat pieces into a casing and chilling the meat pieces while the meat pieces are in the casing.

In some embodiments, chilling the meat pieces comprises freezing the meat pieces.

In some embodiments, the casing is slack-filled with the meat pieces.

In some embodiments, the casing is edible.

In some embodiments, the casing is non-edible.

In some embodiments, the method further comprises the step of removing, by the system, the casing prior to the slicing step.

In some embodiments, the forming step comprises freezing the meat pieces while the meat pieces are separated and molding the frozen meat pieces together using a pressure mold.

In some embodiments, the method further comprises the step of injecting, by the system, the meat pieces with an additive prior to the forming step.

In some embodiments, the method further comprises the step of tumbling, by the system, the meat pieces with an additive prior to the forming step.

In some embodiments, the additive is a curing agent.

In some embodiments, the additive is a seasoning.

In some embodiments, the meat slices are substantially uniform in size.

In some embodiments, the meat slices are placed on the conveyor in a manner that maintains substantially uniform spacing between adjacent ones of the meat slices.

In some embodiments, the meat slices are placed on the conveyor while the conveyor is stationary.

In some embodiments, the meat slices are placed on the conveyor while the conveyor is in motion.

In some embodiments, the meat slices are dried while arranged on the conveyor with substantially uniform spacing between adjacent ones of the meat slices.

In some embodiments, the method further comprises the step of packaging, by the system, the dried meat slices.

In another aspect of the invention, a whole-muscle jerky slice comprises a first portion of dried meat having intact muscle fiber, wherein the first portion is sourced from a first animal and cut from a bulk form; and a second portion of dried meat having intact muscle fiber integral with the first portion, wherein the second portion is sourced from a second animal and cut from the bulk form.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows an automated system for preparing whole-muscle jerky slices in a first embodiment of the invention.

FIG. 2 shows an automated system for preparing whole-muscle jerky slices in a second embodiment of the invention.

FIG. 3 shows an automated method for preparing whole-muscle jerky slices using the system of FIG. 1.

FIG. 4 shows an automated method for preparing whole-muscle jerky slices using the system of FIG. 2.

### DETAILED DESCRIPTION OF A PREFERRED EMBODIMENT

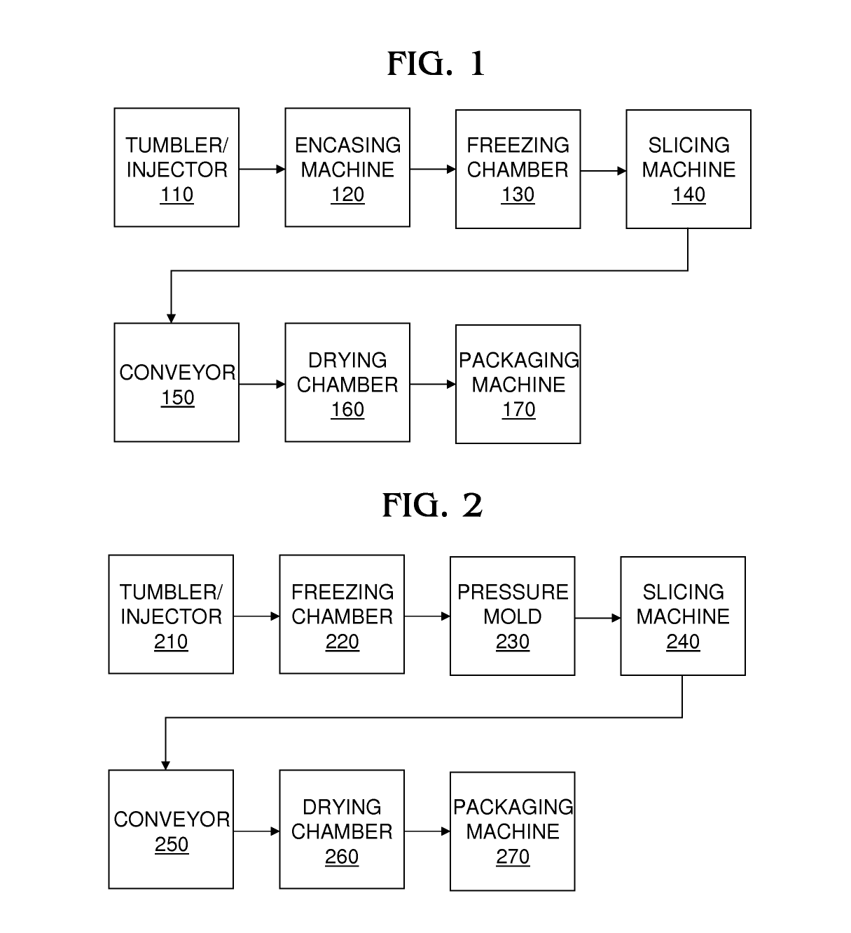

FIGS. 1 and 2 show automated systems for preparing whole-muscle jerky slices in a first and second embodiment of the invention. In both embodiments, whole-muscle pieces of meat, such as beef, pork, lamb, chicken, turkey or fish, are applied as a system input and packaged whole-muscle jerky slices are produced as a system output. The inputted whole-muscle meat pieces and outputted whole-muscle jerky slices have intact muscle fiber and the appearance of natural meat, as distinguished from blended meat. Moreover, due to bulk form processing employed by these automated systems, the whole-muscle jerky slices may be produced using small pieces of meat or residual trimmings generated when producing other meat products and with minimal human intervention. Notably, whole-muscle jerky slices cut by these automated systems from the same bulk form may have a first portion of meat sourced from a first animal and a second portion of meat sourced from a second animal.

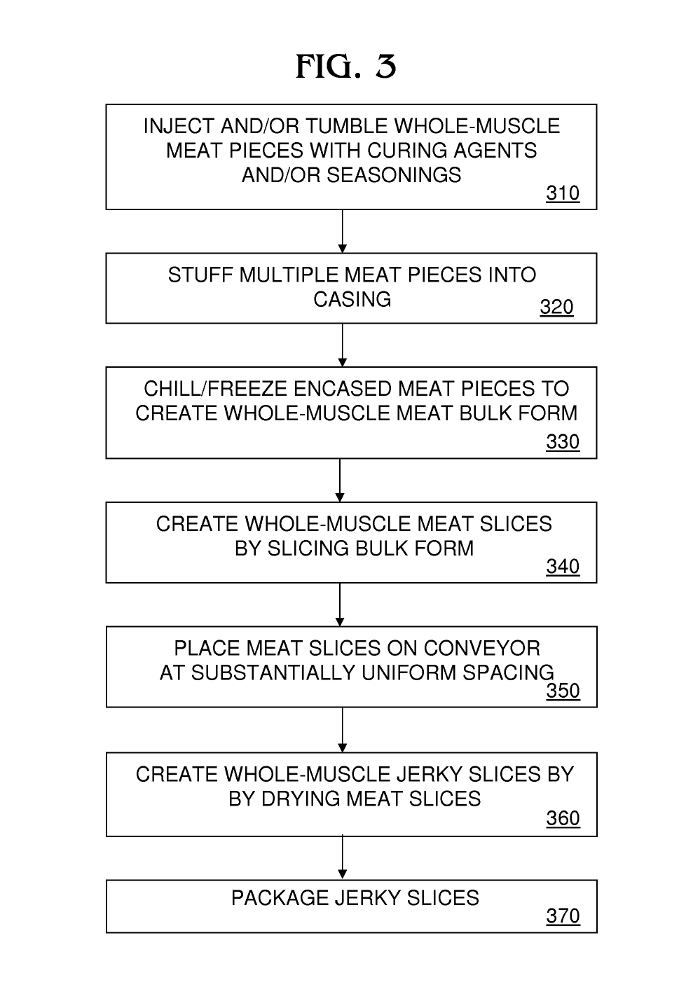

Turning to FIG. 3, an automated method for preparing whole-muscle jerky slices using the system of FIG. 1 is shown. In this automated method, a whole-muscle meat bulk form is created from separate whole-muscle meat pieces by stuffing the separate meat pieces into a casing.

First, multiple whole-muscle meat pieces are injected or tumbled by an injector or tumbler 110 with one or more additives, such as curing agents or seasonings (310). The injected or tumbled meat pieces are delivered in a continuous or batch-wise manner to an encasing machine 120 which stuffs the multiple meat pieces into a casing (320). The casing may be a non-edible casing, such as a plastic casing of suitable size and shape, or an edible casing, such as a sausage casing of suitable size and shape. In either case, the casing is slack-filled with the meat pieces. That is, the casing is only partially filled with the meat pieces so as to form, when subsequently chilled, a whole-muscle meat bulk form having a non-uniform cross-section and gaps. Slack-filling facilitates in yielding as output from the system whole-muscle jerky slices having a natural shape.

Once the meat pieces have been stuffed into the casing, the casing is sealed by encasing machine 120 and deposited in a freezing chamber 130 where the casing remains until the meat pieces are sufficiently chilled to form a whole-muscle meat bulk form capable of being cut into thin slices (330). Chilling may involve freezing the bulk form or a lesser degree of chilling. Once sufficiently chilled, the bulk form is fed into a slicing machine 140 that thinly slices the chilled bulk form into multiple substantially uniform whole-muscle meat slices (340). Where a non-edible casing is used, the casing is removed prior to slicing. The meat slices are placed onto a conveyor 150 while maintaining substantially uniform spacing between each meat slice to allow for uniform drying (350). In one embodiment, slicing machine 140 times placement of the meat slices so that each meat slice falls onto a tray positioned on moving conveyor belt or directly onto the moving conveyor belt with appropriate spacing. In another embodiment, slicing machine 140 spaces placement of the meat slices so that the meat slices are dropped with appropriate spacing onto a tray positioned on a stationary conveyor belt or directly onto the stationary conveyor belt. Once on conveyor 150, the meat slices are delivered in a continuous or batch-wise manner to a drying chamber 160 where evaporative drying is performed on the meat slices while arranged on the conveyor with substantially uniform spacing between adjacent meat slices to reduce the water content of the meat slices and convert the meat slices into whole-muscle jerky slices (360). After drying, and optional smoking, the jerky slices are delivered in continuous or batch-wise fashion to a packaging machine 170 which packages the jerky slices (370) in preparation for distribution.

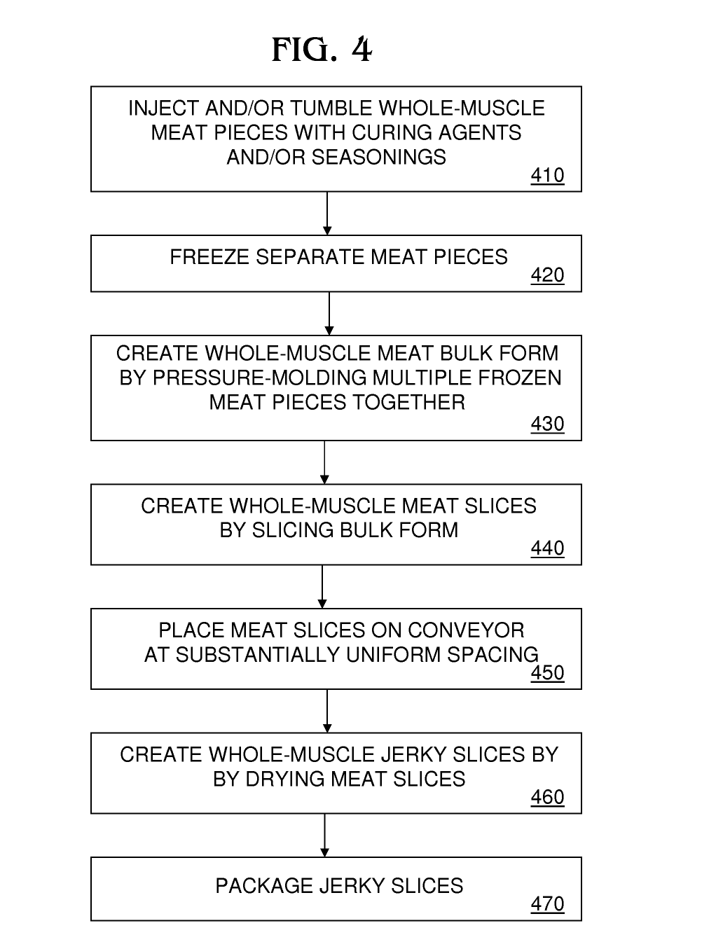

Turning to FIG. 4, an automated method for preparing whole-muscle jerky slices using the system of FIG. 2 is shown. In this automated method, a whole-muscle meat bulk form is created from separate whole-muscle meat pieces by freezing individual meat pieces and molding them together using a pressure mold.

First, multiple whole-muscle meat pieces are injected or tumbled by an injector or tumbler 210 with desirable curing agents or seasonings (410). The injected or tumbled meat pieces are delivered in a continuous or batch-wise manner to a freezing chamber 220 where the meat pieces are separated and frozen (420). In one embodiment, freezing is performed using a continuous spiral freezer. The individually frozen meat pieces are fed into a pressure mold 230 which molds the individually frozen meat pieces into a whole-muscle meat bulk form (430). Pressure mold 230 creates the bulk form by applying pressure that creates lasting adhesion between the frozen meat pieces. The bulk form is fed into a slicing machine 240 that thinly slices the frozen bulk form into multiple substantially uniform whole-muscle meat slices (440). The meat slices are placed onto a conveyor 250 while maintaining substantially uniform spacing between each meat slice to allow for uniform drying (450). In one embodiment, slicing machine 240 times placement of the meat slices so that each meat slice falls onto a tray positioned on moving conveyor belt or directly onto the moving conveyor belt with appropriate spacing. In another embodiment, slicing machine 240 spaces placement of the meat slices so that the meat slices are dropped with appropriate spacing onto a tray positioned on a stationary conveyor belt or directly onto the stationary conveyor belt. Once on conveyor 250, the meat slices are delivered in a continuous or batch-wise manner to a drying chamber 260 where evaporative drying is performed on the meat slices while arranged on the conveyor with substantially uniform spacing between adjacent meat slices to reduce the water content of the meat slices and convert them into whole-muscle jerky slices (460). After drying, and optional smoking, the jerky slices are delivered in continuous or batch-wise fashion to a packaging machine 270 which packages the jerky slices (470) in preparation for distribution.

In both of the above-described automated methods, through the expedient of bulk form processing, whole-muscle jerky slices are capable of being produced using small cuts of whole-muscle meat and with minimal human involvement.

It will be appreciated by those of ordinary skill in the art that the invention can be embodied in other specific forms without departing from the spirit or essential character hereof. The present description is considered in all respects to be illustrative and not restrictive. The scope of the invention is indicated by the appended claims, and all changes that come with in the meaning and range of equivalents thereof are intended to be embraced therein.

What is claimed is:

1. An automated method for producing whole-muscle jerky slices, comprising the steps of:
forming, by an automated system, a chilled bulk form from a plurality of separate meat pieces having intact muscle fiber;
slicing, by the system, the chilled bulk form into a plurality of meat slices having intact muscle fiber;
placing, by the system, the meat slices on a conveyor; and
drying, by the system, the meat slices.

2. The method of claim 1, wherein the forming step comprises stuffing the meat pieces into a casing and chilling the meat pieces while the meat pieces are in the casing.

3. The method of claim 2, wherein chilling the meat pieces comprises freezing the meat pieces.

4. The method of claim 2, wherein the casing is slack-filled with the meat pieces.

5. The method of claim 2, wherein the casing is edible.

6. The method of claim 2, wherein the casing is non-edible.

7. The method of claim 2, further comprising the step of removing, by the system, the casing prior to the slicing step.

8. The method of claim 1, wherein the forming step comprises freezing the meat pieces while the meat pieces are separated and molding the frozen meat pieces together using a pressure mold.

9. The method of claim 1, further comprising the step of injecting, by the system, the meat pieces with an additive prior to the forming step.

10. The method of claim 9, wherein the additive is a curing agent.

11. The method of claim 9, wherein the additive is a seasoning.

12. The method of claim 1, further comprising the step of tumbling, by the system, the meat pieces with an additive prior to the forming step.

13. The method of claim 12, wherein the additive is a curing agent.

14. The method of claim 12, wherein the additive is a seasoning.

15. The method of claim 1, wherein the meat slices are substantially uniform in size.

16. The method of claim 1, wherein the meat slices are placed on the conveyer in a manner that maintains substantially uniform spacing between adjacent ones of the meat slices.

17. The method of claim 16, wherein the meat slices are placed on the conveyor while the conveyor is stationary.

18. The method of claim 16, wherein the meat slices are placed on the conveyor while the conveyor is in motion.

19. The method of claim 16, wherein the meat slices are dried while arranged on the conveyor with substantially uniform spacing between adjacent ones of the meat slices.

20. The method of claim 1, further comprising the step of packaging, by the system, the dried meat slices.
